(19) United States
(12) Patent Application Publication
(10) Pub. No.: US 2025/0042155 A1
(43) Pub. Date: Feb. 6, 2025

(54) CAP DEVICE

(71) Applicant: Roland DG Corporation, Hamamatsu-shi (JP)

(72) Inventors: Akira SUWADA, Hamamatsu-shi (JP); Kazuhiro IDA, Hamamatsu-shi (JP); Yu KAMIYAMA, Hamamatsu-shi (JP); Kikuo MATSUBA, Hamamatsu-shi (JP)

(21) Appl. No.: 18/897,229

(22) Filed: Sep. 26, 2024

Related U.S. Application Data
(63) Continuation of application No. PCT/JP2022/016260, filed on Mar. 30, 2022.

(51) Int. Cl. B41J 2/165

(52) U.S. Cl. CPC B41J 2/16511

(57) ABSTRACT

A cap device, which is provided in a printer device and capable of blocking an ink ejection port, includes a casing body including a casing bottom portion and a casing wall portion, a top surface of the casing body being open, a cap assembly integrally supported by the casing body and including a cap support and a cap body capable of covering the ink ejection port, and an engaging portion that allows the casing body and the cap assembly to be attached to and detached from a cap mounting portion.

### CROSS REFERENCE TO RELATED APPLICATIONS

This application is a Continuation application of PCT Application No. PCT/JP2022/016260 filed on Mar. 30, 2022. The entire contents of this application are hereby incorporated herein by reference.

### BACKGROUND OF THE INVENTION

### 1. Field of the Invention

The present invention relates to cap devices usable in printers to block an ink ejection port.

### 2. Description of the Related Art

A cap device capable of blocking an ink ejection port is installed in many printers. By capping the ink ejection port during a mode other than a printing mode in which printing is performed on a medium, the drying of ink adhering to the ink ejection port and the clogging of the ink ejection port can be reduced or prevented. As such a cap device, for example, the technology described in Japanese Unexamined Patent Publication No. 2019-181758 is known.

A cap device known from Japanese Unexamined Patent Publication No. 2019-181758 includes a cap body covering an ink ejection port from below, a casing body on which the cap body is detachably mounted, and a biasing structure that biases the casing body toward the injection port.

A hole through which ink is capable of passing is formed in the cap body, and the ink adhering to the ink ejection port can be suctioned by generating negative pressure using a pump or the like.

### SUMMARY OF THE INVENTION

Some of the ink adhering to the ejection port adheres to the cap body. When the adhering ink hardens, a nozzle surface cannot be blocked, or the suction hole formed in the cap body is blocked, thereby causing problems with suction. Therefore, the cap body is periodically replaced.

The cap body can be attached to and detached from the casing body. The casing body is supported from below by a spring, and is movable in an up-down direction and a horizontal direction. For that reason, it is difficult to perform the work of replacing a cap due to movement of the casing body in the up-down direction and the horizontal direction during the replacement of the cap body. There is room for improvement in terms of improving workability in the work of replacing the cap body.

Example embodiments of the present invention provide cap devices that each allow a cap body to be easily replaced.

According to an example embodiment of the present disclosure, a cap device that is displaceable relative to an ink ejector capable of ejecting ink from an ink ejection port, and capable of blocking the ink ejection port, includes a casing body including a casing bottom portion and a casing wall portion extending from the casing bottom portion, a top surface of the casing body being open, a cap assembly integrally supported by the casing body, and including a cap support and a cap body supported by the cap support and capable of covering the ink ejection port; and an engaging portion to allow the casing body to be attached to and detached from a cap device mounting portion.

According to example embodiments of the present disclosure, it is possible to provide cap devices that allow the cap body to be easily replaced.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is a perspective view of a printer device according to an example embodiment, and FIG. 1B is a plan view of a carriage of the printer device shown in FIG. 1A.

FIG. 2 is a perspective view of a cap device included in the printer device shown in FIG. 1A.

FIG. 3 is a cross-sectional view taken along line 3-3 of FIG. 2.

FIG. 4A is a view describing a step of preparing a tube, FIG. 4B is a view describing a step of twisting the tube in a circumferential direction around an axis of the tube, FIG. 4C is a view describing a step of forming a loop portion by twisting the tube, which is twisted in the circumferential direction, in an axial direction, and FIG. 4D is a view describing a step of connecting the tube to a casing body and a cap assembly in a state where a biasing force is applied in the circumferential direction and a state where the loop portion is held.

FIG. 5A is a view describing the action when the cap device is raised, and FIG. 5B is a view describing the action of the cap device in a state where ink ejection ports are blocked (capped state).

FIG. 6 is an exploded perspective view of a printer device according to a first modification example.

FIG. 7 is an exploded perspective view of a printer device according to a second modification example.

### DETAILED DESCRIPTION OF THE EXAMPLE EMBODIMENTS

Example embodiments of the present invention will be described below based on the accompanying drawings. Incidentally, in the description, the left and right refer to the left and right with reference to a state where a user faces a printer device, and the front and rear refer to the front and rear with reference to a direction of feeding of paper by the printer device. In addition, in the figures, Fr, Rr, Le, Ri, Up, and Dn represent the front, the rear, the left, the right, the top or up, and the bottom or down, respectively.

### EXAMPLE EMBODIMENTS

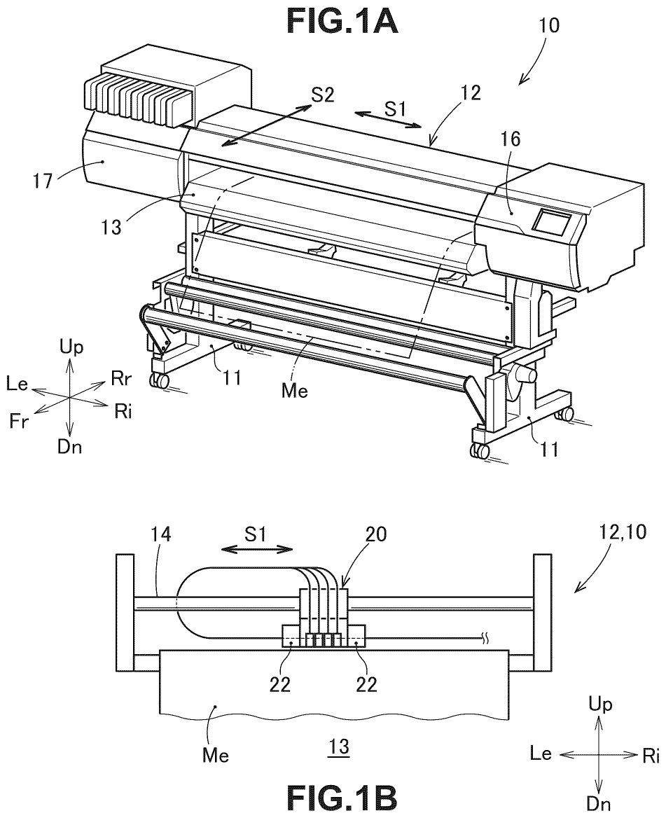

Referring to FIG. 1A, a printer device 10 includes left and right leg portions 11 and 11 on which casters are provided, and a printing unit 12 supported by the leg portions 11 and 11, and capable of performing printing.

Incidentally, the printer device 10 may not include casters on the leg portions 11 and 11, and may include only the printing unit 12.

Referring also to FIG. 1B, the printing unit 12 includes a table portion 13 which is provided at the center of the printing unit 12, and on which a print object Me such as paper can be placed, a rail 14 extending in a left-right direction above the table portion 13, an ink ejector 20 provided to be movable on the rail 14 (refer to arrow S1), and capable of ejecting ink, and lid portions 16 and 17 provided at left and right end portions, and capable of swing in an up-down direction.

The rail 14 extends to a portion covered by the lid portions 16 and 17, and the ink ejector 20 is also movable from above the table portion 13 to the portion covered by the lid portions 16 and 17.

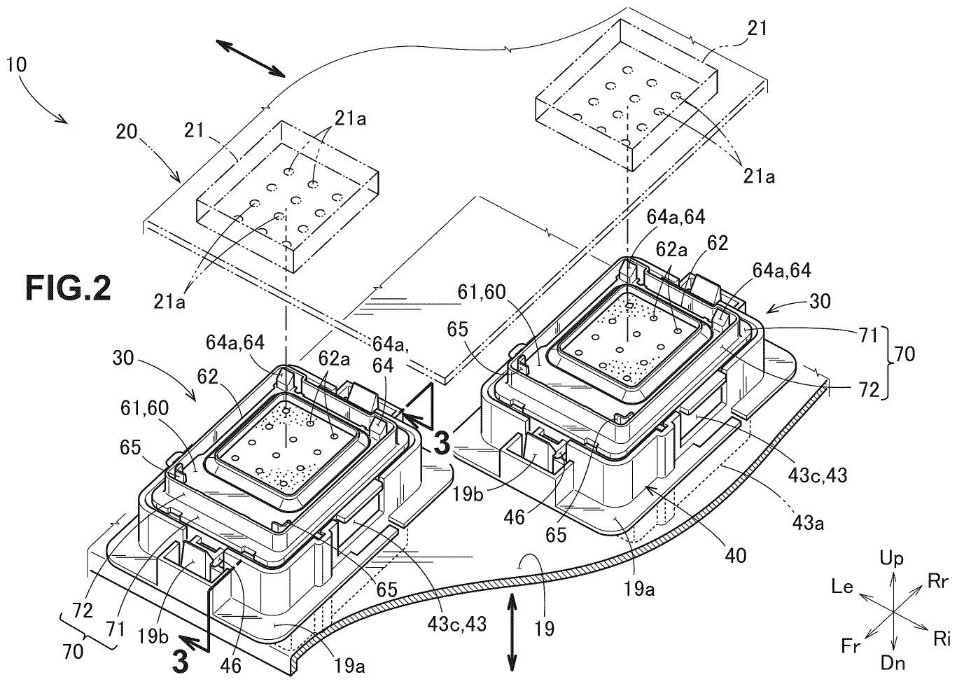

Referring to FIG. 1B and FIG. 2, the ink ejector 20 is also referred to as a carriage. For example, an ejector 21 that ejects ultraviolet-curable ink and a ultraviolet lamp 22 that irradiates the ejected ink with ultraviolet light are installed in the ink ejector 20.

For example, when the print object Me is paper, the paper is fed on an upper surface of the table portion 13 from the rear toward the front (refer to arrow S2 in FIG. 1A). The ink ejector 20 ejects the ultraviolet-curable ink toward the paper while moving in the left-right direction (refer to arrow S1). The ejected ink is irradiated with ultraviolet light by the ultraviolet lamp 22, so that the ink is cured. Accordingly, a predetermined pattern or the like can be printed on the paper.

The print object Me may be a medium other than paper, and as for the ink, ink other than ultraviolet-curable ink may also be adopted.

Referring to FIG. 2, the ink ejector 20 includes ink ejection ports 21a, which are capable of ejecting the ink, in the ejector 21. In addition, a cap device mounting portion 19 is provided at the portion, which is covered by the lid portion 16 (refer to FIGS. 1A and 1B), to be movable up and down. A cap device 30 capable of blocking the ink ejection ports 21a is provided on a mounting body portion 19a having a cup shape and constituting the cap device mounting portion 19.

For example, two cap devices 30 and 30 are provided on the cap device mounting portion 19. Each of the cap devices 30 and 30 is detachably provided on the cap device mounting portion 19. The cap devices 30 are 30 are displaced together in the up-down direction by moving the cap device mounting portion 19 up and down. Since the cap devices 30 and 30 have the same configuration, the cap device 30 on the left side will be described below as an example.

Incidentally, three or more cap devices 30 and 30 or one cap device 30 may be provided according to the number or shape of the ink ejection ports 21a.

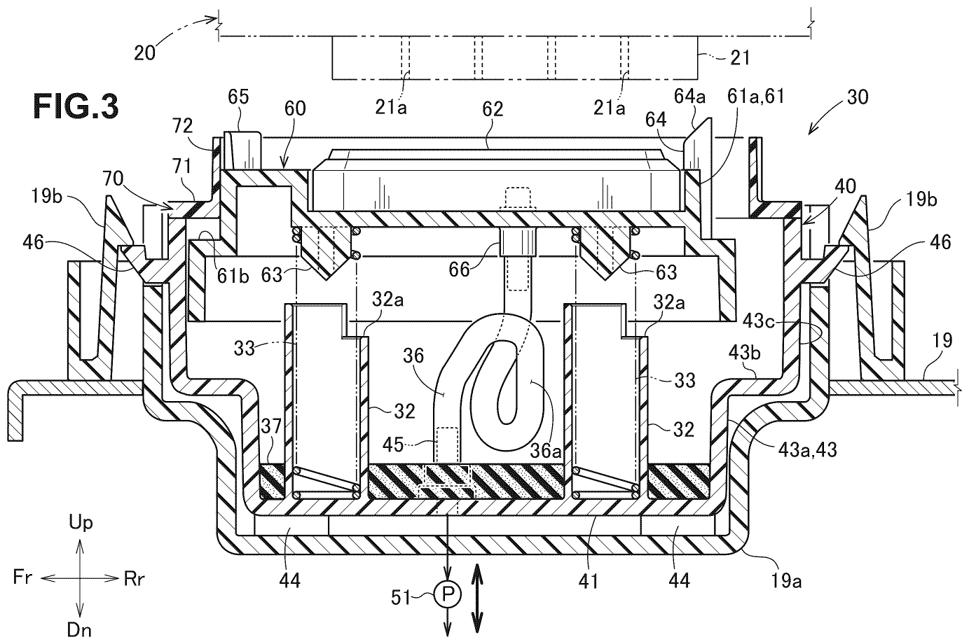

Referring to FIG. 3, FIG. 3 shows the cap device 30 at a standby position separated from the ink ejector 20.

The cap device 30 includes a casing body 40 with a cup shape, the top of which is open, a tubular portion 32 having a tubular shape, which extends from a casing bottom portion 41 that is the bottom portion of the casing body 40, a biasing structure 33 stored in the tubular portion 32, and including a coil spring, a cap assembly 60 capable of being biased toward the ink ejector 20 by the biasing structure 33, and capable of covering the ink ejection ports 21a; a cover 70 that is supported on an upper portion of the casing body 40, and that restricts the popping out of the cap assembly 60 from the casing body 40; a tube 36 having a tube shape, which is connected from the cap assembly 60 to the casing body 40, and an ink absorber 37 placed on the casing bottom portion 41, and capable of absorbing the ink.

The casing body 40 includes the casing bottom portion 41 as a bottom plate having a substantially rectangular shape, a casing wall portion 43 extending from each edge of the casing bottom portion 41, and casing leg portions 44 extending downward from the casing bottom portion 41. A top surface of the casing body 40 is open.

A bottom portion ink discharge portion 45 to which a lower end of the tube 36 is connected and including a hole to discharge the ink to the outside is located on the casing bottom portion 41. A pump 51 to suction the ink is connected to the bottom portion ink discharge portion 45.

The casing wall portion 43 includes a first wall portion 43a extending from the casing bottom portion 41, an expanded portion 43b expanding outward from an upper end of the first wall portion 43a, a second wall portion 43c extending from an outer end portion of the expanded portion 43b, and a cover locking hole portion which is a hole provided in the second wall portion 43c and to which the cover 70 is locked.

An engaging portion 46 that engages with a mounting-side pawl portion 19b on the mounting body portion 19a is provided on the second wall portion 43c. A portion of the engaging portion 46, which is in contact with the second wall portion 43c, preferably has a recessed shape. The mounting-side pawl portion 19b can be bent toward the outside.

The cap device 30 can be removed from the cap device mounting portion 19 by lifting the cap device 30 in a state where the mounting-side pawl portion 19b is bent toward the outside. In addition, when the cap device 30 is pushed into the mounting body portion 19a, the engaging portion 46 comes into contact with the mounting-side pawl portion 19b. When the cap device 30 is further pushed in a state where the engaging portion 43d is in contact with the mounting-side pawl portion 19b, the mounting-side pawl portion 19b is bent, and the cap device 30 can be further pushed in. When the cap device 30 is disposed at a predetermined position, the mounting-side pawl portion 19b returns to above the engaging portion 46, and the cap device 30 is prevented from coming out.

The engaging portion 46 may be provided on two second wall portions 43c facing each other among four second wall portions 43c. It is not necessary to provide all the second wall portions 43c.

The tubular portion 32 is a cylindrical portion formed integrally with the casing bottom portion 41, and a lower end of the tubular portion 32 is closed by the casing bottom portion 41. The biasing structure 33 is positioned by the tubular portion 32. A relief portion 32a with a cutout shape to allow the biasing structure 33 to be displaced in a radial direction is provided at a portion of an upper end (open end) of the tubular portion 32.

The biasing structure 33 is stored in the tubular portion 32, and biases the cap assembly 60 upward. The biasing structure 33 is stored in the casing body 40 and is capable of transmitting a biasing force from the casing bottom portion 41 toward the top surface. For example, four biasing structures 33 are provided.

The cap assembly 60 is provided on the casing body 40 in a state where the cap assembly 60 is displaceable in a vertical direction and a horizontal direction. The cap assembly 60 includes a cap support 61 biased upward by the biasing structure 33, a cap body 62 supported by the cap support 61, and capable of covering the ink ejection ports 21a, a biasing structure guide portion 63 extending downward from a lower surface of the cap support 61, and protruding to the inside of an upper end of the biasing structure 33, a guide protruding portion 64 protruding upward from an upper surface of the cap support 61, and capable of coming into contact with the ink ejector 20, a projection portion 65 protruding upward from a corner of the upper surface of the cap support 61, and including a substantially L-shape along the corner, and a ceiling portion ink discharge portion 66 which is provided on the cap support 61, and to which an upper end of the tube 36 is connected.

The cap support 61 includes a cap body storage portion 61a including a cup shape with an open upper surface, and in which the cap body 62 is stored, and a cap extension portion 61b extending from the cap body storage portion 61a toward the second wall portions 43c.

Referring also to FIG. 2, the cap body 62 includes a rubber structure having a substantially rectangular shape in a plan view, and a portion of the cap body 62 corresponding to each corner is biased by the biasing structure 33. The cap body 62 is provided with an absorber through which the ink is capable of passing when the ink adhering to the ink ejection ports 21a is suctioned. The absorber is fixed inside the cap body 62 by a plurality of absorber fixing portions 62a.

Referring only to FIG. 3, the biasing structure guide portion 63 has a substantially pentagonal shape, which gradually narrows in width as the biasing structure guide portion 63 extends downward, with reference to a biasing direction of the biasing structure 33, and has an X-shape with reference to a bottom view. Namely, the biasing structure guide portion 63 is such that two plates having a substantially pentagonal shape, which narrow in width as the plates extend downward, intersect each other in a substantially X-shape. Since the width of a tip of the biasing structure guide portion 63 is narrowed, the biasing structure 33 is allowed to be displaced in the radial direction.

Incidentally, the biasing structure guide portion 63 may have a cylindrical shape, or can have any other shape.

Two guide protruding portions 64 are provided at both left and right ends (refer also to FIG. 2). The guide protruding portions 64 have guide surface portions 64a that are inclined with respect to the cap body 62. The guide surface portions 64a are surfaces capable of coming into contact with the ink ejector 20 when the cap body 62 and the ink ejector 20 approach each other.

When the cap device 30 rises, first, the guide surface portions 64a come into contact with the ink ejector 20. When the cap device 30 further rises, the guide surface portions 64a come into contact with the ink ejector 20, so that the cap assembly 60 is displaced to the right side of the drawing. For this reason, it can be said that the guide surface portions 64a are inclined with respect to a direction in which the cap assembly 60 slides.

It can also be said that the guide protruding portions 64 have the guide surface portions 64a which are located in front of the cap body 62 with reference to a direction in which the cap assembly 60 is moved in the horizontal direction when the cap device 30 has risen, and which include a downward slope toward the cap body 62.

Two projection portions 65 are provided at both left and right ends (refer also to FIG. 2). The projection portions 65 are located behind the cap body 62 with reference to the direction in which the cap assembly 60 is moved in the horizontal direction when the cap device 30 has risen.

The ceiling portion ink discharge portion 66 includes a hole to suction the ink through the cap body 62.

The cover 70 includes a cover body 71 extending from tips of the second wall portions 43c toward the inside to cover a portion of the top surface of the casing body 40, and a dam wall portion 72 extending from an inner end portion of the cover body 71 to a position higher than the cap body 62. The cap assembly 60 is capable of protruding from a region surrounded by the dam wall portion 72.

At least a portion of the cover body 71 overlaps the cap extension portion 61b in the up-down direction. Even when the cap assembly 60 is displaced upward, the popping out of the cap assembly 60 from the casing body 40 can be reduced or prevented since the cap extension portion 61b comes into contact with the cover body 71.

Incidentally, the dam wall portion 72 may be moved to a position higher than an upper end of the cap body 62 when the cap body 62 is in close contact with the ink ejection ports 21a. More preferably, in a state where the cap body 62 is separated from the ink ejection ports 21a, the dam wall portion 72 is moved to a position higher than the upper end of the cap body 62. The reason will be described later.

The tube 36 is, for example, a rubber tube to discharge the ink to the outside of the casing body 40, the ink being suctioned from the ink ejection ports 21a.

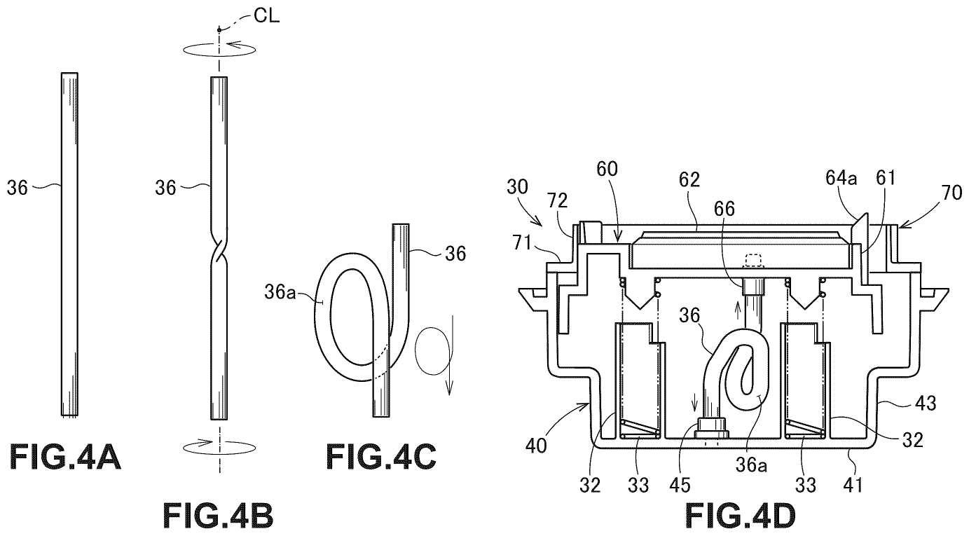

A method for mounting the tube 36 will be described with reference to FIGS. 4A to 4D. As shown in FIG. 4A, first, the tube 36 is prepared (preparation step). Next, as shown in FIG. 4B, the tube 36 is twisted in a circumferential direction around an axis CL of the tube 36 (step of twisting the tube 36 in the circumferential direction). Next, as shown in FIG. 4C, a loop portion 36a including an annular shape is formed by twisting the tube 36 in an axial direction in a state where the tube 36 is twisted in the circumferential direction (step of forming a loop portion). Next, as shown in FIG. 4D, in a state where the biasing force is applied in the circumferential direction and a state where the loop portion 36a is held, the tube 36 is connected to the casing body 40 and the cap assembly 60 (connecting step).

As described above, the tube 36 includes the loop portion 36a to which the biasing force is applied in the circumferential direction and which is bent in a loop shape in a state where the tube 36 is mounted on the casing body 40 and the cap assembly 60.

Referring to FIG. 3, the ink absorber 37 is including, for example, a sponge provided inside the casing body 40 to absorb the ink that has overflowed into the casing body 40.

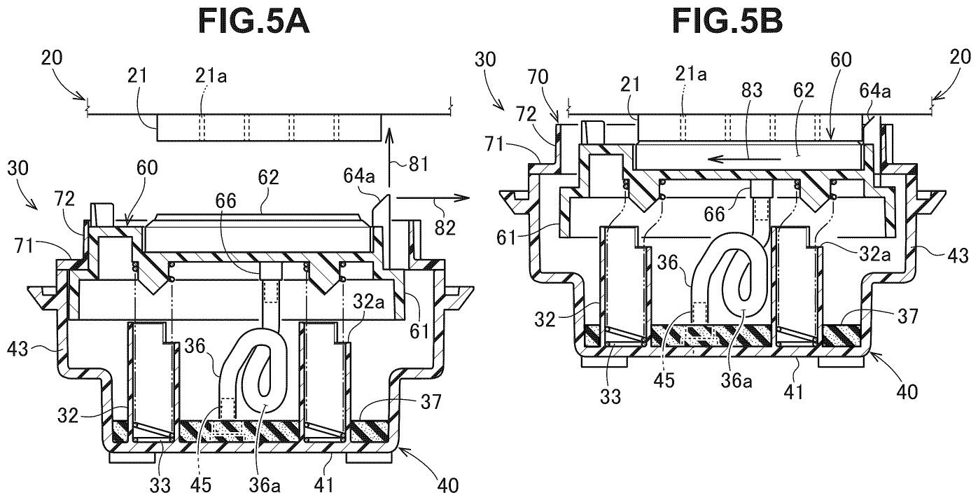

FIG. 5A shows the cap device 30 located at the standby position during a printing mode in which the ink ejector 20 performs printing. FIG. 5B shows the cap device 30 located at a capping position where the ink ejection ports 21a are blocked.

Referring to FIG. 5A, for example, when printing is completed, the ink ejector 20 moves to above the cap device 30. More precisely, the ink ejector 20 stops at a position slightly offset with respect to the cap body 62.

When the ink ejector 20 stops, the cap device 30 rises as indicated by arrow 81. When the cap device 30 rises, the guide surface portions 64a come into contact with the ink ejector 20. When the cap device 30 further rises, the cap device 30 is pushed against the ink ejector 20, and the cap assembly 60 is displaced in the horizontal direction as indicated by arrow 82. The cap device 30 moves up until the cap body 62 blocks the ink ejection ports 21a.

Referring to FIG. 5B, when the cap device 30 is located at the capping position, as indicated by arrow 83, the cap assembly 60 is biased by the biasing structures 33 in a direction in which the cap device 30 returns to the standby position. In addition, the cap assembly 60 is biased toward the ink ejector 20 by the biasing structures 33.

By bringing the cap body 62 into close contact with the ink ejection ports 21a, the drying of the ink with which the ejector 21 is filled can be reduced or prevented. In addition, by operating the pump 51 (refer to FIG. 2) in a state where the cap body 62 is in close contact with the ink ejection ports 21a, the ink adhering to the ink ejection ports 21a and the like can be discharged to the outside of the casing body 40.

The cap device 30 described above will be summarized.

Referring to FIG. 3 and FIGS. 5A and 5B, the cap device 30 is displaceable relative to the ink ejector 20 capable of ejecting the ink from the ink ejection ports 21a, and is capable of blocking the ink ejection ports 21a.

The cap device 30 includes the casing body 40 including the casing bottom portion 41 and the casing wall portion 43 extending from the casing bottom portion 41, the top surface of the casing body 40 being open, the cap assembly 60 integrally supported by the casing body 40, and including the cap support 61 and the cap body 62 supported by the cap support 61 and capable of covering the ink ejection port 21a, and the engaging portion 46 that allows the casing body 40 to be attached to and detached from the cap device mounting portion 19.

In the cap device 30, the cap assembly 60 is integrally supported by the casing body 40. Furthermore, the casing body 40 can be attached to and detached from the cap device mounting portion 19 via the engaging portion 46. By unitizing the casing body 40 and the cap assembly 60, when the replacement of the cap body 62 is necessary, the entirety of the cap device 30 can be removed from the printer device 10 (refer to FIG. 2), and can be replaced with a new cap device 30. Accordingly, when the cap body 62 is replaced, the cap body 62 can be attached to and detached from a printer body in a stable state, instead of being attached to and detached from the unstable casing body provided to move up, down, left, and right. It is possible to provide the cap device 30 that allows the cap body 62 to be easily replaced.

Further, the cap device 30 includes the biasing structure 33 stored in the casing body 40, and capable of transmitting a biasing force to the cap assembly 60 from the casing bottom portion 41 toward the top surface. Furthermore, the cap assembly 60 is capable of being biased toward the ink ejector 20 by the biasing structure 33. Even in a state where the biasing force is applied to the cap body 62, the cap device can be easily replaced in a stable state.

The cap body 62 has a substantially polygonal shape when viewed from above (refer also to FIG. 2), and the biasing structure 33 is provided at a portion corresponding to each corner of the cap body 62. Accordingly, the entirety of the cap body 62 can be uniformly biased toward the ink ejector 20, and the ink ejection port 21a can be more reliably closed. In addition, since the entirety of the cap body 62 can be uniformly biased, the cap body 62 can be brought into close contact with the ink ejection port 21a with a minimum load. The load applied to the ink ejection port 21a and the like can be reduced, which is preferable.

The cap assembly 60 is provided to be slidable in a substantially horizontal direction from the standby position (FIG. 5A) where the cap assembly 60 is separated from the ink ejector 20 to the capping position (FIG. 5B) where the cap assembly 60 blocks the ink ejection port 21a, and is biased in a direction of the standby position when the cap assembly 60 is located at the capping position. By biasing the cap body 62 not only in the vertical direction but also in the horizontal direction, the ink ejection port 21a can be blocked at a more accurate position.

The cap assembly 60 further includes the guide protruding portion 64 protruding from the cap support 61 to be able to come into contact with the ink ejector 20. The guide protruding portion 64 includes the guide surface portion 64a that is a surface capable of coming into contact with the ink ejector 20 when the cap body 62 and the ink ejector 20 approach each other, and that is inclined with respect to a direction in which the cap assembly 60 slides. In a state where the guide surface portion 64a is in contact with the ink ejector 20, the cap body 62 and the ink ejector 20 further approach each other, so that the guide surface portion 64a is pushed against the ink ejector 20, and is slidable in the substantially horizontal direction.

The ink ejection port 21a and the cap body 62 are offset from each other in advance, and the cap body 62 is displaced also in the horizontal direction while being brought closer to the ink ejection port 21a. The position of the cap body 62 or the ink ejection port 21a is slightly shifted for each device due to inevitable dimensional errors and the like. By making it possible to displace the cap body 62 not only in the vertical direction but also in the horizontal direction, the cap body 62 can be guided to a more accurate position, so that close contact between the cap body 62 and the ink ejection port 21a is improved.

The tubular portion 32 with a substantially tubular shape extends from the casing bottom portion 41, and the biasing structure 33 including a coil spring is stored in the tubular portion 32. By simply inserting the biasing structure 33 into the tubular portion 32, the biasing structure 33 can be easily disposed at an accurate position, and the biasing structure 33 can be prevented from falling over. As a result, the cap body 62 can be more reliably biased toward the ink ejection port 21a. In addition, by surrounding an outer periphery of the biasing structure 33 with the tubular portion 32, the biting of the biasing structure 33 into approaching other members (the tube 36 and the like) can be reduced or prevented.

The cap device 30 further includes the tube 36 having a tube shape, which is connected from the cap assembly 60 to the casing body 40 to discharge the ink to the outside of the casing body 40, the ink being suctioned from the ink ejection port 21a. The tube 36 includes the loop portion 36a to which a biasing force is applied in the circumferential direction, and which is bent in a loop shape.

In the cap device 30, the cap assembly 60 is biased and displaced by the biasing structure 33. When the cap assembly 60 is displaced, the tube 36 is also displaced, for example, extends or contracts. By applying the biasing force to the tube 36 in the circumferential direction, and bending the tube 36 in a loop shape, the tube 36 can be prevented from being folded when displaced, and is allowed to smoothly follow the displacement of the cap assembly 60.

An outer periphery of the cap body 62 is surrounded by the dam wall portion 72 extending to a position higher than the upper end of the cap body 62 with reference to a state where the cap body 62 is in close contact with the ink ejection port 21a. Even if the ink overflows onto an upper surface of the cap body 62 when the ink is suctioned, the scattering of the ink to the outside of the cap device 30 can be reduced or prevented by the dam wall portion 72. Further, in a case where the dam wall portion 72 is higher than the cap body 62 with reference to a standby state, even when the cap body 62 is separated from the ink ejection port 21a in a state where the ink overflows around the cap body 62, the scattering of the ink can be reduced or prevented.

The cap device 30 further includes the cover 70 that is supported by the casing body 40, that covers a portion of the top surface, and that restricts popping out of the cap assembly 60 from the casing body 40. In addition, the dam wall portion 72 is provided in the cover 70. The scattering of the ink can be reduced or prevented without increasing the number of components, which is preferable.

The ink absorber 37 capable of absorbing the ink is provided inside the casing body 40. The leakage of the ink to the outside of the cap device 30 can be reduced or prevented.

In addition, the cap device 30 can also be described as follows. Referring to FIG. 3 and FIGS. 5A and 5B, the cap device 30 includes the casing body 40 including the casing bottom portion 41 and the casing wall portion 43 extending from the casing bottom portion 41, the top surface of the casing body 40 being opened, the biasing structure 33 stored in the casing body 40, and capable of transmitting a biasing force from the casing bottom portion 41 toward the top surface, the cap assembly 60 capable of being biased toward the ink ejector 20 by the biasing structure 33, and including the cap support 61 and the cap body 62 supported by the cap support 61 and capable of covering the ink ejection port 21a, and the cover 70 that is supported by the casing body 40, that covers a portion of the top surface, and that restricts popping out of the cap assembly 60 from the casing body 40.

In the cap device 30, the biasing structure 33 is stored in the casing body 40, and the cap assembly 60 is prevented from popping out from the casing body 40 by the cover 70 supported by the casing body 40. By unitizing the casing body 40, the biasing structure 33, the cap assembly 60, and the cover 70, when the replacement of the cap body 62 is necessary, the entirety of the cap device 30 can be removed from the printer device 10 (refer to FIG. 2), and can be replaced with a new cap device 30. Accordingly, when the cap body 62 is replaced, the cap body 62 can be attached to and detached from the printer body in a stable state instead of an unstable state where the casing body is provided to move up, down, left, and right. It is possible to provide the cap device 30 that allows the cap body 62 to be easily replaced.

Incidentally, example embodiments of the present invention has been described taking as an example a printer device that uses ultraviolet-curable ink. However, the printer device in which the cap devices are installed is not limited to a printer device that uses ultraviolet-curable ink.

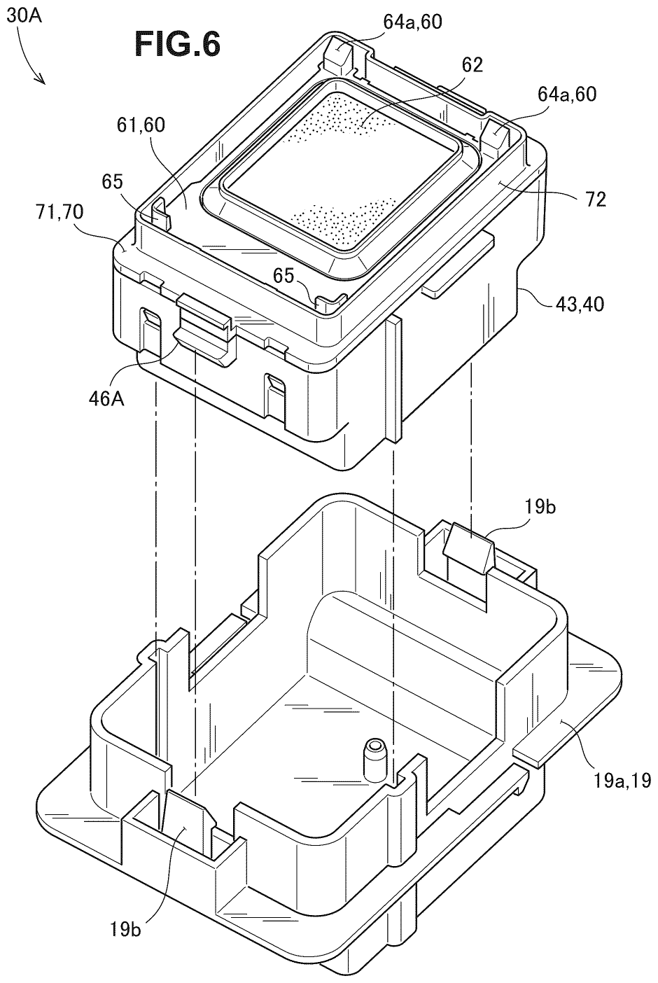

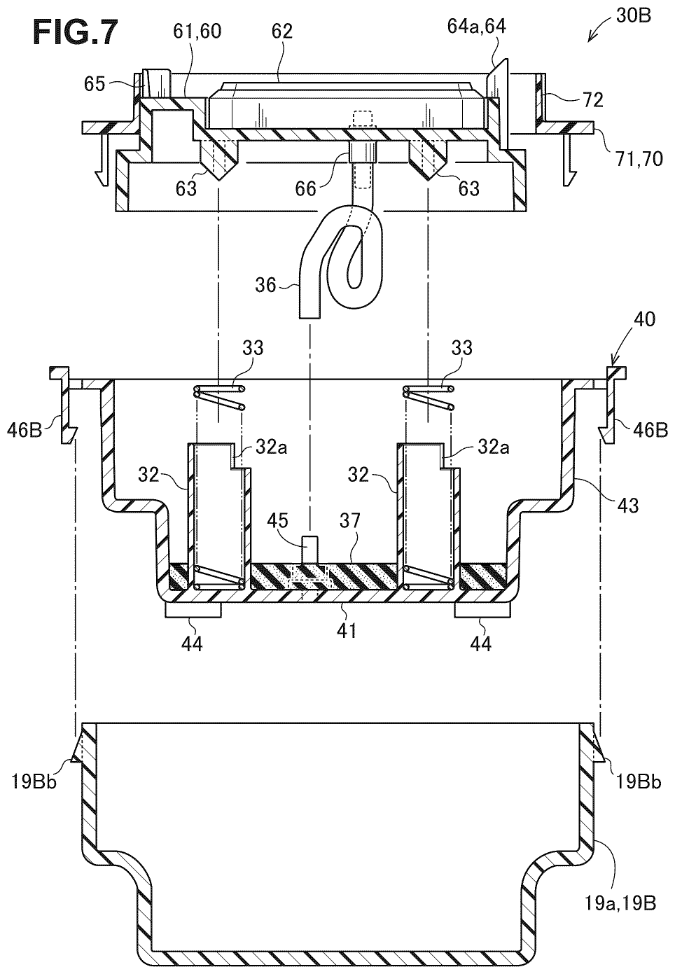

Referring to FIG. 6 and FIG. 7, FIG. 6 shows a cap device 30A according to a first modification example. In addition, FIG. 7 shows a cap device 30B according to a second modification example. The cap devices 30A and 30B according to the modification examples also have the same basic configuration as the cap device 30 according to the example embodiments described above (refer to FIG. 3), and the same configurations as the cap device 30 according to the example embodiments reuse the same reference letters and numerals, and the description thereof will be omitted.

Particularly, as shown in FIG. 6, an engaging portion 46A that engages with the mounting-side pawl portion 19b may include a pawl shape. In addition, particularly, as shown in FIG. 7, an engaging portion 46B with a pawl shape may be engaged with a mounting-side engaging portion 19Bb defining a portion of a cap device mounting portion 19B. The engaging portion 46B is engaged with the mounting-side engaging portion 19Bb from the outside.

As long as the engaging portion is configured to detachably engage with the cap device mounting portion, a pawl or a projection can be adopted as the configuration of the engaging portion. In addition, any shape can be adopted as the shape of the pawl or the projection.

Cap devices according to example embodiments of the present invention is suitable for a printer device that uses ultraviolet-curable ink.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A cap device that is displaceable relative to an ink ejector capable of ejecting ink from an ink ejection port, and capable of blocking the ink ejection port, the cap device comprising:
a casing body including a casing bottom portion and a casing wall portion extending from the casing bottom portion, a top surface of the casing body being open;
a cap assembly integrally supported by the casing body, and including a cap support and a cap body supported by the cap support and capable of covering the ink ejection port; and
an engaging portion to allow the casing body to be attached to and detached from a cap device mounting portion.

2. The cap device according to claim 1, further comprising:
a biasing structure stored in the casing body, and capable of transmitting a biasing force to the cap assembly from the casing bottom portion toward the top surface; wherein
the cap assembly is capable of being biased toward the ink ejector by the biasing structure.

3. The cap device according to claim 2, wherein
the cap body has a substantially polygonal shape when viewed from above; and
the biasing structure is provided at a portion corresponding to each corner of the cap body.

4. The cap device according to claim 2, wherein the cap assembly is slidable in a substantially horizontal direction from a standby position where the cap assembly is separated from the ink ejector to a capping position where the cap assembly blocks the ink ejection port, and is biased in a direction of the standby position when the cap assembly is located at the capping position.

5. The cap device according to claim 4, wherein
the cap assembly further includes a guide protruding portion protruding from the cap support to be able to come into contact with the ink ejector;
the guide protruding portion includes a guide surface portion that is a surface capable of coming into contact with the ink ejector when the cap body and the ink ejector approach each other, and that is inclined with respect to a direction in which the cap assembly slides; and
in a state where the guide surface portion is in contact with the ink ejector, the cap body and the ink ejector further approach each other, so that the guide surface portion is pushed against the ink ejector, and is slidable in the substantially horizontal direction.

6. The cap device according to claim 2, wherein a tubular portion with a substantially tubular shape extends from the casing bottom portion, and the biasing structure including a coil spring is stored in the tubular portion.

7. The cap device according to claim 1, further comprising:
a tube connected from the cap assembly to the casing body to discharge the ink to an outside of the casing body such that the ink is suctioned from the ink ejection port;
the tube includes a loop portion to which a biasing force is applied in a circumferential direction, and which is bent in a loop shape.

8. The cap device according to claim 1, wherein an outer periphery of the cap body is surrounded by a dam wall portion that extends to a position higher than an upper end of the cap body with reference to a state where the cap body is in close contact with the ink ejection port.

9. The cap device according to claim 8, further comprising:
a cover that is supported by the casing body, that covers a portion of the top surface, and that restricts popping out of the cap assembly from the casing body; wherein
the dam wall portion is located in the cover.

10. The cap device according to claim 1, wherein an ink absorber capable of absorbing the ink is provided inside the casing body.
